(19) United States
(12) Patent Application Publication
(10) Pub. No.: US 2021/0101648 A1
(43) Pub. Date: Apr. 8, 2021

(54) AIR GUIDING OR DEFLECTING SYSTEM AND METHOD FOR OPERATING SUCH SYSTEM

(71) Applicant: Rumblestrip AB, Göteborg (SE)

(72) Inventors: Gustav Kristiansson, Vreta Kloster (SE); Emanuel Walldén Viklund, Rijswijk (NL)

(21) Appl. No.: 16/464,573

(22) PCT Filed: Nov. 29, 2017
(86) PCT No.: PCT/EP2017/080747

§ 371 Date: May 28, 2019

(30) Foreign Application Priority Data
Nov. 30, 2016 (SE) 1651572-8

(51) Int. Cl. B62D 35/00; B62D 37/02

(52) U.S. Cl. CPC B62D 35/001; B62D 37/02

(57) ABSTRACT

The present application relates to a method and a system for operation of an air guide or deflection member of a vehicle. The method comprising: providing an air guiding or deflecting member, movably attached to the vehicle, providing an electrically drivable actuator, driving the actuator to adjust an orientation of the member relative to the vehicle, measuring a current of the actuator, determining the current derivative value, and determining a desired orientation of the member based on the current derivative value. The system comprising an air guiding or deflecting member, an electrically drivable actuator, and a controller. The controller is configured to measure a current of the actuator, determine a current derivative value, and determine a desired orientation of the member based on the current derivative value. This arrangement enables adjustment of the member's position into an optimal orientation without connection or communication with other systems of the vehicle.

### TECHNICAL FIELD

The present disclosure relates to an air guiding or deflecting system and to a method of operating a position or orientation of an air guiding or deflecting member of the system relative a vehicle. The method and system find particular application in air guiding or air deflecting devices which are electrically adjustable. Such air guiding or air deflecting devices may be used on land vehicles, such as on trucks or lorries, or on cars that are used to tow a load, such as a trailer or a caravan.

### BACKGROUND

Vehicles, such as heavy trucks carrying a load and trucks towing a trailer, are often equipped with air guiding devices, air deflectors, located on the roof of the truck/tractor cab and/or on respective lateral sides of the truck/tractor cab, for reducing air drag during journey and thereby reducing fuel consumption of the vehicle.

When travelling, vehicles displace air, and for a vehicle carrying load or towing a trailer which extends upwards and/or sideways beyond the vehicle, the front surface of extended parts of the load or trailer will cause significant air drag. The air guiding device, if correctly aligned, redirects the air which is moving over the moving vehicle in such a way that the air does not hit the front edge of the trailer or the load carried by the vehicle but instead the air is moving over the roof or along the sides of the carried load or the trailer.

The dimensions of trailers and of load carried by the vehicle often vary, why, in some applications, it is desirable to adjust the position or orientation of the air guiding means for optimal reduction of the air drag for each truck-load or truck-trailer combination.

Presently know devices, such as those disclosed in GB2465393 or EP2915926A1, determine an optimal position by detecting the air pressure exerted on the deflective device by a plurality of sensors which is costly as well as unreliable as the sensors are exposed to the harsh environment of the deflecting device or there is a need to correlate measured values with those of other systems of the vehicle. A further known system is disclosed in EP2626281A1, in which an air guiding device can be automatically adjusted by means of an electric motor. A parameter corresponding to the adjustment force required by the motor during movement of the air guiding device between two positions is registered by a control unit which then moves the air guiding device to a position corresponding to the minimum value of the registered parameter.

It is desirable to achieve a durable method and system for optimizing the position of a deflecting device that does not require communication with other systems of the vehicle, as this would facilitate e.g. retrofitting of an automatically adjustable guiding or deflecting device.

Hence, there is a need for a method and a system for finding the optimal position of an air guiding means on a vehicle that is durable, reliable, and that is independent of other systems of the vehicle.

### SUMMARY

An object of the present invention is thus to provide a method and a device for finding the optimal position of an air guiding means on a vehicle, and in particular a method which can be used with a minimum of communication with the vehicle and with a minimum of components.

The invention is defined by the appended independent claims, with embodiments being set forth in the appended dependent claims, in the following description and in the drawings.

According to a first aspect, there is provided a method of operation of an air guiding or deflecting member of a vehicle comprising; providing an air guiding or deflecting member, which is movably attached to the vehicle, providing an electrically drivable actuator, which is arranged to adjust an orientation of the air guiding or deflecting member relative to the vehicle, driving the actuator to adjust the orientation of the air guiding or deflecting member relative to the vehicle, measuring a drive parameter of the actuator, determining a drive parameter derivative value, and determining a desired orientation of the air guiding or deflecting member based on the drive parameter derivative value.

The invention is based on the understanding that for an actuator operating at a fixed voltage, a drive parameter, such as the instantaneous current consumption, of the actuator required to move the air guiding or deflecting member, is closely related to the force exerted on the air guiding or deflecting member. The force will depend on static factors, such as the weight of the member and the friction between moving parts of the member and the actuator, as well as on dynamic factors, such as the vehicle's velocity.

With this arrangement, the operation of moving the air guiding or deflecting member into the desired orientation can be performed independently of any connection or communication with other systems of the vehicle.

By measuring the drive parameter of the actuator, the value of the drive parameter derivative can be determined and this in turn may be used to determine the desired orientation without the need of input from other systems of the vehicle. The drive parameter derivative is defined as the speed of change of the actuator drive parameter relative to the orientation of the air guiding or deflecting member. By determining the desired orientation based on the drive parameter derivative of the actuator, an effective and cost-efficient method of determining a desired orientation of the air guiding or deflecting member may be provided.

By determining the desired orientation based on the drive parameter derivative it may be meant that the drive parameter derivative is used as input for the operation of determining the desired orientation. Further, determining the desired orientation based on the drive parameter derivative value may signify that the orientation can be determined by using the drive parameter derivative value and comparing the value to a predetermined set of values. Depending on the correlation between the drive parameter derivative value and the predetermined set of values, the value of the drive parameter derivative corresponding to the desired orientation may be determined.

Providing an air guiding or deflecting member may signify that an air guiding or deflecting member is part of a system in which the operation is performed.

Providing an electrically drivable actuator may signify that an actuator is part of a system in which the operation is performed.

The desired positon may be referred to as the optimal positon or orientation in terms of that a minimum air drag is exerted on the vehicle. In the optimal orientation the air guiding or deflecting member may be oriented at approximately the same height or width of the trailer such that all air flow may be guided around the vehicle and no extra force is exerted on the vehicle as may be the case when the air guiding means are located in the stagnated flow orientation and an orthogonal surface of a load or trailer thus may be exposed to the air flow.

The desired orientation may be indicated by a shift in the drive parameter derivate from a lower value level or range to a higher value level or range or vice versa. A shift in the drive parameter derivative may indicate that the load exerted on the air guiding or deflecting member has changed from a lower to a higher load or from a higher to a lower load. The desired orientation may be located between these two loads, i.e. where the shift takes place between the higher/lower to the lower/higher value level or range of the drive parameter derivative. The drive parameter derivative may be considered to be in a value level or range when it is within a predetermined range of values or within a predetermined deviation from a predetermined specified value. Such deviation may for instance be within +/−1-5% of the predetermined specified value. A higher value level refers to a level which has a higher predetermined specified value or range value than that of the lower value level. The shift in the drive parameter derivative may be a change in the drive parameter derivative value of at least 5-20%.

The lower value level or range of the drive parameter derivative may signify that the orientation of the air guiding or deflecting member is in a stagnated flow of a trailer of the vehicle. A lower value level or range may signify that the air guiding or deflecting member is oriented below the height or inside the width of the vehicle.

The higher value level or range of the drive parameter derivative may signify that the orientation of the air guiding or deflecting member is above the stagnated flow of a trailer of the vehicle. This orientation may indicate that the air drag on the air guiding or deflecting member or deflector is relatively higher than in the stagnated flow orientation, thus the drive parameter derivative value or range has a higher value.

The desired orientation of the air guiding or deflecting member may be determined by calculating an orientation corresponding to the shift in the drive parameter derivative. By calculating the orientation corresponding to the shift in the drive parameter derivative, the air guiding or deflecting member may be reoriented into the orientation corresponding to this shift and thus oriented into the optimal orientation with respect to air drag on the vehicle. Further, by calculating an orientation based on the drive parameter derivative, there may be no need for communication or connections to other systems of the vehicle.

The step of determining the desired orientation may comprise the steps of:
determining a first orientation of the air guiding or deflecting member corresponding to a first drive parameter derivative value deviating from said lower or higher value level or range,
determining a second orientation of the air guiding or deflecting member corresponding to a second drive parameter derivative value reaching said higher or lower value level or range, and
determining said desired orientation as an orientation in-between said first orientation and said second orientation.

By determination of the first and second orientations where the drive parameter derivative deviates from drive parameter lower or higher value level or range, the shift in the drive parameter derivative and its corresponding orientation can be determined.

The first orientation of the air guiding or deflecting member may be either in an orientation corresponding to a higher drive parameter derivative value level or a lower drive parameter derivative level depending on whether the air guiding or deflecting member is moving from a stagnated flow orientation to an orientation above the trailer roof or in the opposite direction.

The drive parameter derivative value may be considered to deviate form a value level or range when it deviates from a predetermined range of values. It may also be considered to deviate from a value level or range when it deviates more than a predetermined deviation from a predetermined specified value. Further, the drive parameter derivative may be considered to reach a value level or range when it becomes a value within a predetermined range of values, or when it becomes a value above or below a predetermined specified value. As an alternative, the second drive parameter derivative value may be determined when reaching a higher (or lower) value level or range. By reaching it may be meant a determination of the drive parameter derivative value reaching at a predetermined range or a value within an interval of a predetermined value, or increasing or decreasing at a rate below a predetermined level.

The first orientation of the air guiding or deflecting member may be determined when the second derivative of the drive parameter increases above a first predetermined second derivative of the drive parameter, and wherein the second orientation of the air guiding or deflecting member may be determined when the second derivative of the drive parameter decreases below a second predetermined second derivative of the drive parameter. Determining the second derivative of the drive parameter, i.e. the speed of change of the drive parameter derivative, may be used to indicated at which orientation the drive parameter derivative shift is taking place as this desired orientation may be located in between the first orientation corresponding to the first predetermined second derivative of the drive parameter and the second orientation corresponding to the second predetermined second derivative of the drive parameter. An increase above the first predetermined second derivative of the drive parameter may be determined with the first predetermined second derivative value as a threshold providing an instant determination of the first orientation when said threshold is passed. Alternatively, the first predetermined second derivative value may be a value from which the second derivative value may deviate with maximum of 5% of the first predetermined second derivative of the drive parameter for determining the first orientation of the air guiding or deflecting member. A decrease below the second predetermined second derivative of the drive parameter may be determined with the second predetermined second derivative value as a threshold providing an instant determination of the second orientation when said threshold is passed. Alternatively, the second predetermined second derivative value may be a value from which the second derivative value may deviate with maximum of 5% of the second predetermined second derivative of the drive parameter for determining the second orientation of the air guiding or deflecting member.

The first and second predetermined second derivative of the drive parameter may have the same value. The second derivative of the first and second orientations used to calculate the drive parameter derivative shift may be of the same values.

Alternatively, the desired orientation may be determined by a value of the second derivative of the drive parameter. The desired orientation may as an alternative be determined as the orientation corresponding to the maximum value of the second derivate of the drive parameter. The second derivative may be determined when moving the air guiding or deflecting member between two orientations. The air guiding or deflecting member may then be returned to the orientation corresponding to the maximum determined second derivative of the drive parameter of the actuator.

A sequential analysis technique may be used for determining a shift in the drive parameter derivative that corresponds to the desired orientation. Such sequential analysis technique may in one embodiment be performed by a CUSUM detector.

The method may further comprise a step of determining, based on the measured drive parameter, a drive parameter value smoothed over time which may be used as basis for the determination of the drive parameter derivative value. The drive parameter fed to the actuator may fluctuate during the operation of the actuator. In order to determine a drive parameter derivative value that is more reliable in being a basis for the determination of the optimal orientation, a calculation may be made in which the measured drive parameter value is smoothened over time to avoid temporary peaks in the measured drive parameter to affect the determination of the drive parameter derivative. The smoothing operation may comprise calculating a mean value over a time interval. The smoothening may be performed over time intervals in the range of 0.1-1 second.

The actuator may be an electrical motor or an electromechanical actuator driven by an electrical motor.

The vehicle may be a land vehicle, such as a car, truck or lorry, and the air guiding or deflecting member may be an air deflecting member.

According to a second aspect, there is provided an air guiding or deflecting system of a vehicle, comprising an air guiding or deflecting member, which is moveably attached to the vehicle, an electrically drivable actuator, which is arranged to adjust an orientation of the air guiding or deflecting member relative to the vehicle, a controller, which is arranged to drive the actuator to adjust the orientation of the air guiding or deflecting member. The controller is configured to measure a drive parameter of the actuator, determine a drive parameter derivative value, and determine a desired orientation of the air guiding or deflecting member based on the drive parameter derivative value.

With this arrangement, the air guiding or deflecting member can be operated into the desired orientation where air drag and fuel consumption of a vehicle are minimized. Further, the air guiding or deflecting member can be operated into this orientation independently of any connection or communication with other systems of the vehicle.

The moveably attached air guiding or deflecting member may serve to reduce the air drag exerted on the vehicle. To minimize the air drag exerted on the vehicle, a certain orientation of the air guiding or deflecting member where this occurs may be desired.

To obtain the desired orientation of the air guiding or deflecting member, a controller may determine the drive parameter derivative value. When the air guiding or deflecting member is located in the desired orientation, the drive parameter derivative value may exhibit a shift between a lower drive parameter derivative value range or level and a higher derivative value range or level, or between a higher drive parameter derivative value range or level and a lower derivative value range or level. The shift in the drive parameter derivative may be determined by determining a first orientation and a second orientation corresponding to a deviation from the higher or lower value range or level and determining the orientation in between these two orientations as the desired orientation. Alternatively, the value of the second derivative of the drive parameter may be used to determine the desired orientation as the orientation corresponding to the maximum value of the second derivative of the drive parameter.

The controller in the air guiding or deflecting system may comprise a sequential analysis technique or algorithm for determining a shift in the drive parameter derivative of the actuator that corresponds to the desired orientation. In one embodiment, the controller may comprise a CUSUM detector for such determination.

The electric actuator may be a reciprocating engine, an electromechanical actuator, an alternating current motor selected from a group comprising an induction motor, a synchronous, a sliding rotor motor and a repulsion motor, or a direct current motor selected from a group comprising a brushed motor and a brushless motor.

The drive parameter may be selected from a group comprising current of the electric actuator, voltage of the electric actuator, rotations per minute of a rotor of a motor, motor switching frequency, orientation of a piston of a reciprocating engine, motor resistance, motor inductance and motor inertia.

The air guiding or deflecting system may further be configured to realize the functions of the method and embodiments thereof as presented above.

### BRIEF DESCRIPTION OF THE DRAWINGS

FIGS. 1a-c are schematic side views of a truck-trailer combination provided with an air guiding or deflecting member located on the roof of the truck cab.

FIG. 2a is a schematic side-view of a truck cab with an air guiding or deflecting member arranged on the roof of the vehicle.

FIG. 2b is a schematic top-view of a truck cab with a roof-mounted air guiding or deflecting member and air guiding or deflecting members arranged on both lateral sides of the truck cab.

FIGS. 3 and 4 illustrate a graph showing the value of the drive parameter derivate with respect to the air guiding or deflecting member's orientation.

FIG. 5 is a flow chart of a method of controlling an air guiding or deflecting member.

### DETAILED DESCRIPTION

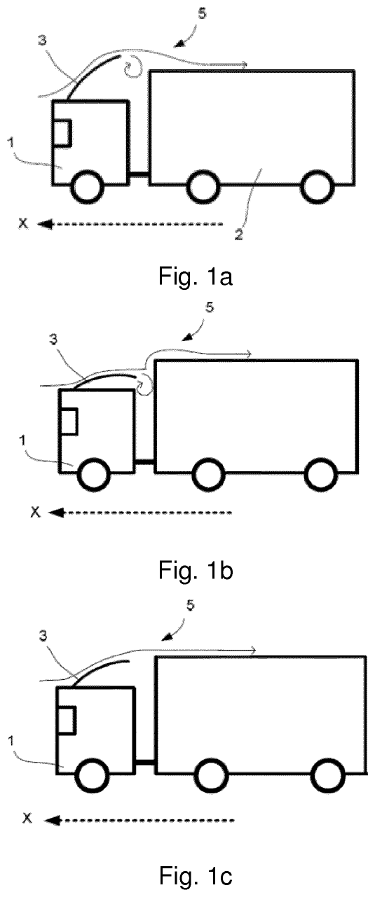

For an automotive ground vehicle such as a truck 1 carrying a load or towing a trailer 2, FIGS. 1a-1c, the front surface of extended parts of the load or trailer 2 will cause significant air drag during journey. Such air drag also occurs for example when a car tows a caravan.

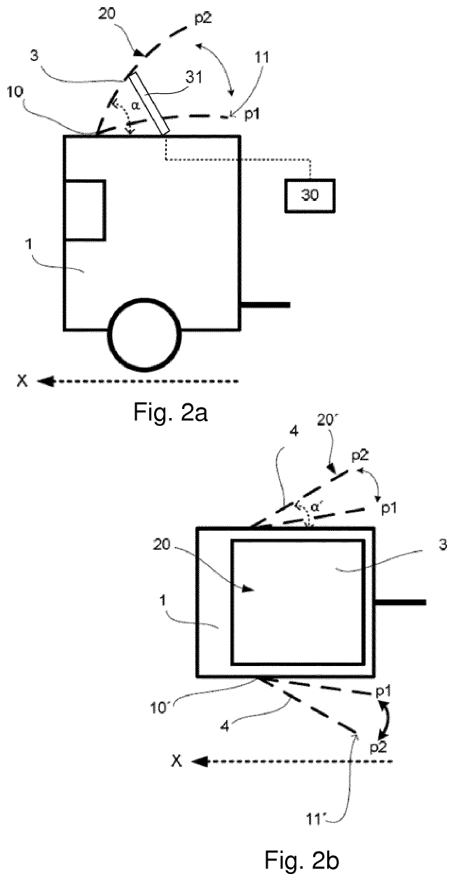

For reducing the air resistance of the vehicle and to reduce fuel consumption, the truck cab 1 may be provided with an air guiding or deflecting member, such as a roof-mounted air deflector 3 (FIGS. 1a-1c and FIG. 2a) and/or side air deflectors 4, mounted on each lateral side of the truck cab 1 (FIG. 2b) for hiding the frontal face area of the trailer 2 load from an oncoming airflow and to get a more streamlined complete vehicle.

Factors that may affect the air resistance are mainly wind direction and wind speed in relation to the vehicle and geometrical factors, namely height and width of the driver's cab 1 relative to the height and width of the trailer 2/load as well as the distance between truck 1 and trailer 2.

The air deflector 3, 4, comprises a major essentially planar air-deflecting surface 20, 20′, which has a first edge 10, 10′ (“leading edge”) and a second edge 11, 11′ (“trailing edge)” essentially opposite the first edge 10, 10′ across the major air-deflecting surface 20, 20′.

When arranged on the truck cab 1 (FIGS. 1a-1c and FIGS. 2a and 2b) the air deflector 3, 4 may be arranged to be pivotable approximately around its first edge 10, 10′ to form an angle of inclination a, a′ of the air-deflecting surface 10, 10′ to a direction X parallel with the normal forward direction of the moving vehicle. When the angle of inclination a, a′ is changed the second edge 11, 11′ is correspondingly translated from one position/orientation to another position/orientation.

The air deflector 3, 4 may have a first extreme position/orientation in which the angle of inclination a, a′ is low, e.g. about 0°-15°, and a second extreme position/orientation in which the angle of inclination a, a′ is high, e.g. about 20°-60°.

For a side-mounted air deflector 4, see FIG. 2b, the second edge 11′ is pivoted around the first edge 10′ forwards and inwards relative to the side of the vehicle forming an angle α′ relative to the longitudinal axis X.

For a roof-mounted air deflector 3, see FIG. 2a, the second edge 11 may be pivoted around the first edge 10 upwards and downwards relative to the roof of the truck cab forming an angle α relative to the longitudinal axis X.

The air deflector 3, 4 may be mounted by means of a frame (not shown) to the truck cab 1 and the air deflector 3, 4 may be moveable with respect to the frame.

The air deflector will, when the vehicle travels, be subject to load from the air, where the load from the air depends on the angle of inclination a, a′ of the air-deflecting surface 20, 20′ and on the condition of the air deflector 3, 4 relative to the load/trailer. Load due to air that flows against the air-deflecting surface 20, 20′ of the air deflector 3, 4 increases as the angle relative to the direction X increases.

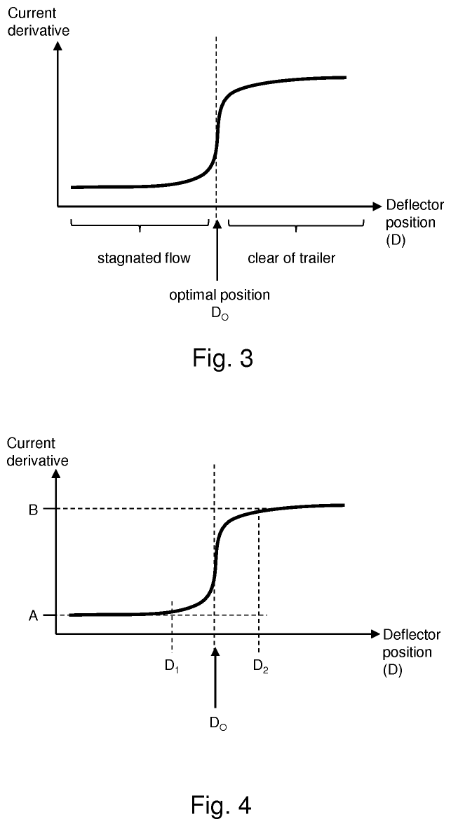

In FIG. 1a the roof-mounted air deflector 3 is moved to a condition such that the second edge 11 of the roof-mounted air deflector 3 is positioned significantly above the height of the trailer 2. The air flowing 5 off the second edge 11 of the air deflector 3 may create a separate flow in an opposite direction in a cavity between the air deflector 3 and the truck cab 1, and thus increase the air drag on the vehicle as compared to an optimally oriented air deflector (see FIG. 1c). This position/orientation is referred to as “clear of trailer” in FIG. 3.

In FIG. 1b the second edge 11 of the air deflector 3 is instead in a position/orientation lower than the height of the forward end of the trailer. This part of the trailer will produce a stagnation of a part of the flow 5. The stagnation of the flow may force an increased air quantity into the cavity and thus create an increased pressure in the cavity and the air drag on the vehicle as compared to an optimally oriented air deflector (see FIG. 1c). This position/orientation is referred to as “stagnated flow” in FIG. 3.

In FIG. 1c the second edge 11 of the air deflector 3 is oriented at the same or approximately the same level as the height of the trailer 2. The air then may flow smoothly over the air guide and further above the roof of the trailer 2. In this optimal position/orientation the airflow 5 is guided around the vehicle during driving, i.e. the air deflector 3 redirects the air which is moving over the moving vehicle in such a way that the air does not hit the front edge of the trailer 2 but instead the air is moving over the roof of the trailer 3. This position/orientation is referred to as ‘optimal’ in FIG. 3.

The same effects are seen for a truck carrying a load having a width extending past the sides of the truck cab. If the load or towed trailer 2 extends laterally outwards of the truck cab 1 the optimal position/orientation of the air deflectors is when the second edge 11′ of the air deflector 4 is oriented at the same or approximately the same level as the width of the trailer 2 or load.

Even small angular variations in the settings of the deflectors 3, 4 may have significant effect on the total vehicle air resistance, and thus on the fuel consumption.

The dimensions of trailers and of load carried by a vehicle often vary, why for optimal reduction of the air drag, the air deflector(s) 3, 4 should be movable.

Traditionally, air deflectors 3, 4 have been manually adjustable. However, it is desirable to, during driving of the vehicle, being able to automatically identify and position/orientation the air deflector 3, 4 for any truck-trailer or truck-load combination into an optimal or close to optimal position/orientation, in which position/orientation the air drag is the lowest.

FIG. 2a further illustrates a controller 30 and an actuator 31, which is in communication with the controller.

The actuator 31 may be any type of actuator that is capable of setting the position/orientation of the air deflector, such as a linearly operating actuator or an angularly operating actuator.

For example, the actuator 31 may be an electrically driven actuator, and in particular one that is drivable by direct current, as that is what is in many cases most readily available in vehicles.

The controller 30 may comprise a processing unit and a memory. Moreover, the controller may be adapted to measure the current and/or voltage fed to the actuator 31.

For example, where the motor is a constant speed motor (e.g. a DC shunt motor) and provided that the voltage can be assumed to be constant, it may be sufficient to measure the current as the drive parameter to be measured.

The system may further comprise a current meter, configured to measure a drive current supplied to the actuator. Current meters are known as such.

Further the system may comprise a detector for detecting the derivative of the drive parameter. The detector may detect a change in a drive parameter, such as the current, by sequential analysis, for example by use of a CUSUM detector.

As illustrated in FIG. 3, the derivative of the drive parameter may be the current derivate and can be used to identify the position/orientation of the optimal position/orientation D_{O} of the air deflector. The power the actuator requires for moving the deflector 3, 4 increases as the inclination of the deflector 3, 4 increases due to the increasing force on the deflector as a larger surface is exposed to the air drag. Assuming that the actuator is operating under constant voltage, this indicates that the current will rise as more power is needed. When the air deflector is in a position/orientation below the height or inside the width of the trailer, i.e. in the stagnated flow position/orientation (FIG. 1b), the power needed for moving the position/orientation of the deflector 3, 4 will be less than when the deflector 3, 4 is clear of the trailer (FIG. 1a). When moving past the optimal position/orientation D_{O} from either the stagnated flow position/orientation to a position/orientation clear of the trailer 2 or vice versa, the derivative of the current will experience a shift as illustrated in FIG. 3. This shift in the derivative of the current indicates when the air deflector 3, 4 passes its optimal position/orientation D_{O} with regard to the trailer 2. By setting adaptive thresholds to the detector, the shift can be detected. By being able to detect the shift, the optimal position/orientation D_{O} can be found independently from other systems of the vehicle. The position/orientation D may also be automatically adjusted as the load changes for example due to increased speed of the vehicle or when the size or load of the trailer 2 relative the truck 1 changes.

In FIG. 4, two values A, B of the current derivative are illustrated. A current derivative value A may correspond to a stagnated flow position/orientation of the air deflector 3, 4 and the current derivative value B may correspond to that the position/orientation of the air deflector 3, 4 is clear of the trailer 2. The two values A, B may also correspond to a range of values where the current derivative value is within a predetermined range deviating according to a predetermined maximum deviation from the two values A, B. To determine the shift in the current derivative, a controller 30 may be configured to identify a deviation in the current derivative from a predetermined lower value range A. The position/orientation of the air deflector 3, 4 when the current derivative is considered to deviate from the value level or range A is determined as a first position/orientation D₁. When the air deflector 3, 4 is continued to be moved, the controller 30 is configured to identify the current derivative reaching a value level or range B. The position/orientation of the air deflector 3, 4 when the current derivative is considered reached the value level or range B is determined as a second position/orientation D₂. The optimal position/orientation D_{O} is then determined as the position/orientation at the middle between the first positon D₁ and the second position/orientation D₂. Hence, when the current derivative value moves from level A to level B or from level B to level A, a current derivative shift is determined to have occurred. The position/orientation of this shift is the position/orientation corresponding to the optimal position/orientation.

The deviation from the current derivative value A may be determined by using the second current derivative, i.e. the speed of change of the current derivative relative to the air deflector position/orientation D. The first position/orientation D₁ is thereby determined at said deviation. When the second derivative value increases above a predetermined value, said deviation is considered to occur. Similarly, the reaching of the current derivative at value level B may be determined using the second current derivative relative to the air deflector position/orientation D. The second position/orientation D₂ is thereby determined at said reaching. When the second derivative value decreases below a predetermined value, the reaching is considered to occur.

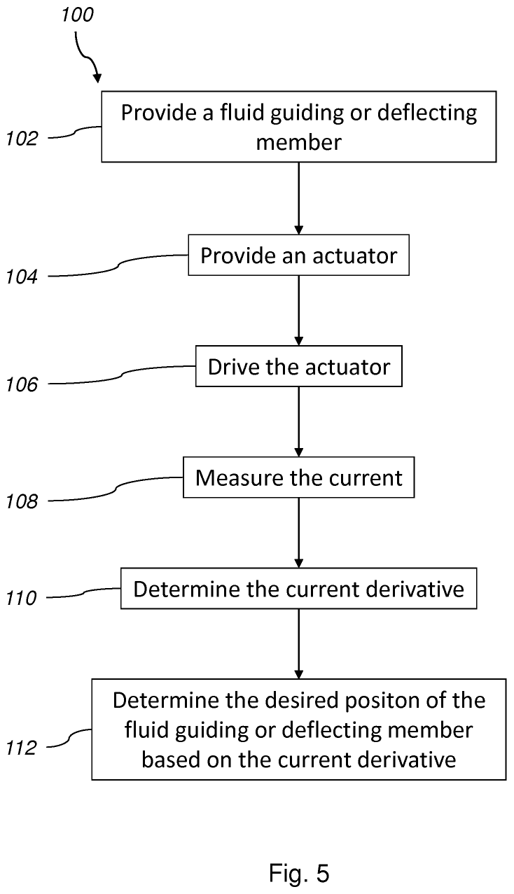

FIG. 5 illustrates a flow chart of the above discussed method 100 of operation of the air guiding or deflecting member. The method 100 comprises the steps of providing 102 the air guiding or deflecting member 20, 20′, which is movably attached to the vehicle, providing 104 an electrically drivable actuator 31, which is arranged to adjust a position/orientation of the air guiding or deflecting member relative to the vehicle, driving 106 the actuator to adjust the position/orientation of the air guiding member relative to the vehicle, measuring 108 a current of the actuator, determining 110 a current derivative value, and determining 112 a desired position/orientation D_{O} of the air guiding or deflecting member based on the current derivative value.

It is noted that the methods described above may all be used regardless of actuator drive direction. That is, the principles disclosed may be used in for a scenario where the air guiding member is moved towards a position/orientation providing greater air resistance, as well as for a scenario where the air guiding member is moved towards a position/orientation providing less air resistance.

1. A method (100) of operation of an air guiding or deflecting member (3, 4) of a vehicle (1) comprising:
providing (102) an air guiding or deflecting member (20, 20′), which is movably attached to the vehicle,
providing (104) an electrically drivable actuator (31), which is arranged to adjust an orientation of the air guiding or deflecting member relative to the vehicle,
driving (106) the actuator to adjust the orientation of the air guiding member relative to the vehicle,
measuring (108) a drive parameter of the actuator,
determining (110) a drive parameter derivative value, and
determining (112) a desired orientation (D_{O}) of the air guiding or deflecting member at a shift in the drive parameter derivative from a lower value level or range (A) to a higher value level or range (B) or vice versa.

2. The method according to claim 1, wherein the lower value level or range (A) of the drive parameter derivative signifies that the orientation of the air guiding or deflecting member (3, 4) is in a stagnated flow of a trailer (2) of the vehicle (1).

3. The method according to claim 1, wherein the higher value level or range (B) of the drive parameter derivative signifies that the orientation of the air guiding or deflecting member (3, 4) is above the stagnated flow of the trailer (2) of the vehicle (1).

4. The method according to claim 1, wherein the desired orientation of the air guiding or deflecting member (3, 4) is determined by calculating an orientation corresponding to the shift in the drive parameter derivative.

5. The method according to claim 1, wherein the step of determining the desired orientation comprises the steps of:
determining a first orientation (D1) of the air guiding or deflecting member corresponding to a first drive parameter derivative value deviating from said lower (A) or higher (B) value level or range,
determining a second orientation (D2) of the air guiding or deflecting member corresponding to a second drive parameter derivative value reaching said higher or lower value level or range, and
determining said desired orientation (DO) as an orientation in-between said first orientation and said second orientation.

6. The method according to claim 5, wherein the first orientation (D1) of the air guiding or deflecting member (3, 4) is determined when the second derivative of the drive parameter increases above a first predetermined second derivative of the drive parameter, and wherein the second orientation (D2) of the air guiding or deflecting member is determined when the second derivative of the drive parameter decreases below a second predetermined second derivative of the drive parameter.

7. The method according to claim 6, wherein the first and second predetermined second derivative of the drive parameter have the same value.

8. The method according to claim 1, wherein the desired orientation (DO) is determined by a value of the second derivative of the drive parameter.

9. The method according to claim 1, further comprising a step of determining, based on the measured drive parameter, a drive parameter value smoothed over time which is used as basis for the determination of the drive parameter derivative value.

10. The method according to claim 1, wherein the actuator (31) is an electrical motor or an electromechanical actuator driven by an electrical motor.

11. The method according to claim 1, wherein the vehicle (1) is a land vehicle, such as a car, truck or lorry, and wherein the air guiding or deflecting member (3, 4) is an air deflecting member.

12. The method according to claim 1, wherein a sequential analysis technique is used for determining a shift in the drive parameter derivative value.

13. An air guiding or deflecting system of a vehicle, comprising:
an air guiding or deflecting member (3, 4), which is moveably attached to the vehicle (1),
an electrically drivable actuator, which is arranged to adjust an orientation of the air guiding or deflecting member relative to the vehicle,
a controller, which is arranged to drive the actuator to adjust the orientation of the air guiding or deflecting member, wherein the controller is configured to:
measure a drive parameter of the actuator,
determine a drive parameter derivative value, and
determine a desired orientation of the air guiding or deflecting member at a shift in the drive parameter derivative from a lower value level or range (A) to a higher value level or range (B) or vice versa.
